(19) United States
(12) Patent Application Publication
(10) Pub. No.: US 2006/0073354 A1
(43) Pub. Date: Apr. 6, 2006

(54) Gas diffusion plate and manufacturing method for the same

(75) Inventors: Keisuke Watanabe, Aichi (JP); Keiji Morita, Aichi (JP); Sachiyuki Nagasaka, Aichi (JP)

Correspondence Address: FOLEY AND LARDNER LLP;SUITE 500, 3000 K STREET NW, WASHINGTON, DC, 20007, US

(73) Assignee: TOSHIBA CERAMICS CO., LTD.

(21) Appl. No.: 11/239,678

(22) Filed: Sep. 30, 2005

(30) Foreign Application Priority Data
Sep. 30, 2004 (JP) 2004-288041
Dec. 2, 2004 (JP) 2004-349946
Aug. 24, 2005 (JP) 2005-242206

(51) Int. Cl. C25D 1/08; B32B 15/00; B32B 15/01

(52) U.S. Cl. 428/596; 428/615; 428/650

(57) ABSTRACT

A gas diffusion plate has an alumina or an aluminum base material provided with one or more through holes and an yttria body shrink-fitted to one of the through holes and provided with one or more gas discharge holes.

The present invention claims foreign priority to Japanese patent application No. P.2004-288041, filed on Sep. 30, 2004, P.2004-349946, filed on Dec. 2, 2004, and P.2005-242206, filed on Aug. 24, 2005, the contents of which are incorporated herein by reference.

### BACKGROUND OF THE INVENTION

1. Field of the Invention

The present invention relates to a gas diffusion plate and a manufacturing method for the same, in particular, a gas diffusion plate in which a cylindrical yttria pipe is shrink-fitted to a circular through hole disposed to an alumina base material or an aluminum base material and a manufacturing method for the same.

2. Description of the Background Art

In a manufacturing process of a semiconductor device, in order to apply a desired process on a surface of a wafer, a plasma processor is employed. This kind of the plasma processor has an upper electrode disposed in an upper portion of a chamber and called also a shower plate. The shower plate is provided with many small diameter gas discharge holes that rectify a reaction gas to eject. The plasma processor further has a lower electrode disposed within the chamber and is connected to a high frequency power source. On an outer periphery of the lower electrode, a focus ring is provided so as to perform uniform plasma processing on a wafer.

When the plasma process is applied by use of such a plasma processor, a silicon wafer is placed on a lower electrode, a reaction gas such as CF₄ supplied from a gas discharge hole of the shower plate is ejected and a high frequency is applied to generate a plasma between a shower plate and the wafer, and thereby a surface of the wafer is processed.

However, in such a plasma processor where plasma is generated between the wafer and the shower plate to apply the etching, not only the wafer but also the shower plate itself is etched, thereby particles are generated, resulting in lowering the manufacturing yield of semiconductor devices.

In this connection, a shower plate in which, in a periphery on a discharge side of the gas discharge hole, a cylindrical pipe made of a material which is higher in the plasma etching resistance than the base material is inserted or a film is formed is proposed in Japanese Patent Unexamined Publication Nos. JP-A-8-227874 and JP-A-2004-6581.

However, the shower plates proposed in the JP-A-8-227874 and JP-A-2004-6581 do not use a material such as yttria or YAG that is said high in the plasma resistance and halogen gas resistance. Accordingly, there is a problem with durability.

In addition, because yttria and YAG are more expensive than an alumina base material and an aluminum base material, a thermal spray coating is formed on the alumina base material or the aluminum base material to improve the corrosion resistance of the surface thereof. However, in the shower plate on which an yttria thermal spray coating is formed, since the yttria thermal spray coating does not reach onto an inner wall portion of the gas discharge hole, it is difficult to form an yttria thermal spray coating on the wall surface of the hole. Furthermore, if it could be applied, the thermal spray coating has poor adhesiveness and can be easily peeled off. In particular, when a thermal spraying material is thermal sprayed perpendicularly to the base material, the thermal spray coating exhibits excellent adhesiveness. However, when the thermal spraying material is obliquely thermal sprayed on an inner surface of the gas discharge hole, excellent adhesiveness is not obtained. Accordingly, inconveniences such as the peeling and particle generation are caused.

Still furthermore, when a bulk of yttria is directly adhered with an adhesive, since the adhesive includes an organic binder, there is a problem in that a gas caused by the organic binder is generated. In addition, there is still another problem in high cost because of the additional adhering process. Furthermore, when single yttria is processed to the bore, there is no problem from a viewpoint of the performance. However, since it is poorer in the strength than the alumina base material or aluminum base material, there is a problem in that the thermal stress during use of the gas diffusion plate may cause its breakage. In addition, the cost regarding the process of single yttria is high, in particular, the larger the dimension is, the higher the cost becomes.

### SUMMARY OF THE INVENTION

The invention was carried out in view of the above-mentioned situations and intends to provide a gas diffusion plate in which yttria excellent in the plasma resistance and the halogen gas resistance is solidly applied over all surfaces of a gas discharge hole disposed to an alumina base material or an aluminum base material, a material inside of the gas discharge hole is inhibited from being etched owing to the discharge to generate particles, and thereby a manufacturing yield of semiconductor can be improved, and that is less expensive; and a manufacturing method thereof.

In order to achieve the above-mentioned object, according to a first aspect of the present invention, there is provided a gas diffusion plate comprising:

an alumina or an aluminum base material provided with one or more through holes; and

an yttria body shrink-fitted to one of the through holes, the yttria body provided with one or more gas discharge holes.

According to a second aspect of the present invention, as set forth in the first aspect of the present invention, it is more preferable that an yttria thermal spray coating is provided on an exposed portion of the alumina or aluminum base material, which is exposed to a corrosive gas.

According to a third aspect of the present invention, as set forth in the first aspect of the present invention, it is more preferable that the through hole of the alumina or the aluminum base material is circular, and the yttria body is cylindrical.

According to a fourth aspect of the present invention, there is provided a manufacturing method for a gas diffusion-plate comprising the steps of:

preparing a prior to sintering alumina base material provided with one or more through holes and a sintered hollow yttria body provided with one or more gas discharge holes;

inserting the sintered hollow yttria body into one of the through holes of the prior to sintering alumina base material; and

sintering the alumina base material together with the sintered hollow yttria body so as to shrink-fit the hollow yttria body to one of the through holes of the alumina base material.

According to a fifth aspect of the present invention, as set forth in the fourth aspect of the present invention, it is more preferable that the manufacturing method for the gas diffusion plate further comprising a step of:

performing an yttria thermal spray coating on an exposed portion of the alumina base material, which is exposed to a corrosive gas.

According to a sixth aspect of the present invention, there is provided a manufacturing method for a gas diffusion plate comprising the steps of:

preparing a prior to sintering alumina base material provided with one or more through holes and a solid sintered yttria body;

inserting the solid sintered yttria body into one of the through holes of the alumina base material;

sintering the alumina base material together with the solid sintered yttria body so as to shrink-fit the solid sintered yttria body to one of the through holes; and

drilling the solid sintered yttria body so as to form one or more gas discharge holes therein.

According to a seventh aspect of the present invention, as set forth in the sixth aspect of the present invention, it is more preferable that the manufacturing method for the gas diffusion plate further comprising a step of:

performing an yttria thermal spray coating on an exposed portion of the alumina base material, which is exposed to a corrosive gas.

According to an eighth aspect of the present invention, there is provided a manufacturing method for a gas diffusion plate comprising the steps of:

preparing an aluminum base material provided with one or more through holes and a hollow sintered yttria body provided with one or more gas discharge holes;

inserting the hollow sintered yttria body into one of the through holes of the aluminum base material while heating the aluminum base;

cooling the hollow sintered yttria body and the aluminum base material so as to shrink-fit the hollow sintered yttria body to one of the through holes.

According to a ninth aspect of the present invention, as set forth in the eighth aspect of the present invention, it is more preferable that the manufacturing-method for the gas diffusion plate further comprising a step of:

performing an yttria thermal spray coating on an exposed portion of the aluminum base material, which is exposed to a corrosive gas.

According to a tenth aspect of the present invention, there is provided a manufacturing method for a gas diffusion plate comprising the steps of:

preparing an aluminum base material provided with one or more through holes and a solid sintered yttria body;

inserting the solid sintered yttria body into one of the through holes of the aluminum base plate;

cooling the aluminum base material and the solid sintered yttria body so as to shrink-fit the solid sintered yttria body to one of the through holes; and

drilling the solid sintered yttria body to form one or more gas discharge holes.

According to an eleventh aspect of the present invention, as set forth in the ninth aspect of the present invention, it is more preferable that the manufacturing method for the gas diffusion plate further comprising a step of:

performing an yttria thermal spray coating on an exposed portion of the aluminum base material, which is exposed to a corrosive gas.

According to the gas diffusion plate as set forth the invention, since the invention is achieved by taking above-mentioned situations into considerations, a gas diffusion plate in which yttria excellent in the plasma resistance and the halogen gas resistance is solidly applied over all surface of a gas discharge hole disposed to an alumina base material or an aluminum base material. Accordingly, a material inside of the gas discharge hole is inhibited from being etched which is occurred by the discharge and the generation of particles therefrom is also prevented. Since the generation of particles is prevented, a manufacturing yield of semiconductor can be improved. Also, a manufacturing method for the gas diffusion plate in less expensive can be provided.

### BRIEF DESCRIPTION OF THE DRAWINGS

FIG. 1 is a perspective view of a gas diffusion palate according to one embodiment of the invention;

FIG. 2 is a vertical sectional view of a gas diffusion plate according to one embodiment of the invention;

FIG. 3 is a vertical sectional view of a gas diffusion plate according to another embodiment of the invention;

FIG. 4 is a perspective view of a gas diffusion palate according to one embodiment of the invention; and

FIG. 5 is a perspective view of an aluminum base material that is used in a manufacturing method for a gas diffusion plate according to a second embodiment of the invention.

### DETAILED DESCRIPTION OF THE PREFERRED EMBODIMENTS

Embodiments of a gas diffusion plate and a manufacturing method for the same according to the invention will be described with reference to the drawings.

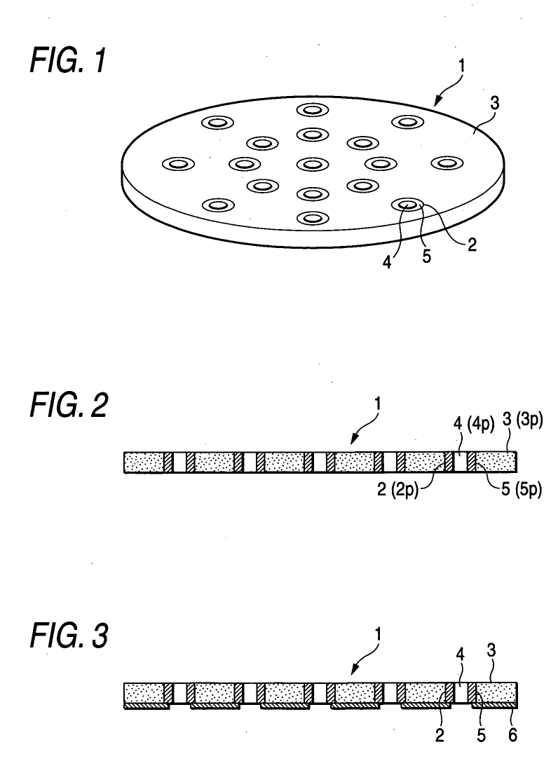

FIG. 1 is a diagram showing a perspective view of a gas diffusion plate according to the invention, and FIG. 2 is a diagram showing a vertical sectional view thereof.

As shown in FIGS. 1 and 2, a gas diffusion plate 1 as for instance a shower plate includes a disk-like alumina base material 3 or an aluminum base material provided with one or more small aperture through holes 2; and a hollow yttria body, for instance, a hollow yttria pipe 5 shrink-fitted to the through hole 2 and provided with a small diameter gas discharge hole 4.

As shown in FIG. 3, in the alumina base material 3 or the aluminum base material, preferably, a portion thereof exposed to a corrosive gas is provided with an yttria thermal spray coating 6. Thereby, the portion where alumina is exposed is inhibited from being etched with a corrosive gas. When the exposed surface is used in a process that is protected with a depo-film, there is no need for any yttria thermal spray coatings.

According to the gas diffusion plate of the invention, in processing a surface film on a semiconductor wafer, for instance, even when the gas diffusion plate is exposed to halogen compound plasma gases such as CCl₄, BCl₃, HBr, CF₄, C₄F₈, NF₃ and SF₆, strongly corrosive ClF₃ self-cleaning gas, or plasma that uses N₂ and O₂ and high in the sputtering properties, the yttria thermal spray coating can inhibit the material from being etched within inside of the gas discharge hole. Accordingly, the corrosion resistance of a surface of the gas discharge hole can be improved, and thereby, without generating particles, a manufacturing yield of semiconductor devices can be improved.

A manufacturing method for a gas diffusion plate according to a first embodiment of the invention is carried out as follows.

As shown in FIG. 2, a disk-like prior to sintering alumina base material 3p provided with many circular through holes 2p and a cylindrical sintered yttria body for instance a cylindrical pipe sintered body 5p provided with gas discharge holes 4p are prepared. Then, previously sintered cylindrical pipe sintered body 5p is inserted in the through hole 2p. Next, the prior to sintering alumina base material 3p and the cylindrical pipe sintered body 5p are simultaneously sintered. After that, by making use of the difference in the thermal contractions of the yttria and alumina, the cylindrical pipe 5 is shrink-fitted to the circular through hole 2.

By using the shrink fitting, the cylindrical pipe sintered body can be assuredly and solidly fixed to the through hole. Further, a gas diffusion plate in which the cylindrical yttria pipe for the gas discharge hole is inserted can be manufactured less expensively.

Further, in view of manufacturing cost, it is preferable that the through hole is circular and the yttria body is cylindrical.

The manufacturing method thereof will be specifically described. A sintering temperature of yttria is normally such high as 1750 to 1850° C. On the other hand, alumina can be sintered at a lower temperature in the range of 1550 to 1700° C. Accordingly, since it is impossible to simultaneously sinter from a viewpoint of temperature, for shrink fitting, it is necessary to use the yttria in which sintering is completed at substantially 1800° C. A hole diameter is set in view of the sintering contraction of alumina and an amount of shrink fitting. A hole is bored in a molded body or a pre-sintered body with thus determined hole diameter. Then, the cylindrical pipe sintered yttria body is inserted therein and the sintering is applied at an ordinary alumina sintering temperature in the range of 1550 to 1650° C. in air, thereby integration of the shower plate can be achieved.

Furthermore, a manufacturing method for a gas diffusion plate according to the invention, which uses an aluminum base material, is carried out as follows.

While the thermal expansion coefficient of yttria ceramics is substantially 6×10⁻⁶, and that of aluminum is substantially 25×10⁻⁶, that is, there is the difference of one order of magnitude in the thermal expansion coefficients. Accordingly, by making use of the difference in the thermal expansion coefficients, the cylindrical pipe sintered yttria body and the aluminum base material can be integrated by use of the shrink fitting.

Specifically, as a cylindrical yttria sintered body, for instance, a cylindrical pipe sintered body, which is sintered at substantially 1800° C., is prepared in advance. One or more circular through holes having a hole diameter of larger by substantially 0 to 0.3 mm than a hole diameter of the cylindrical pipe sintered body are bored in the aluminum base material.

The aluminum base material, in which the circular through holes are bored, is heated at a temperature equal to or more than 300° C. Next, the cylindrical pipe sintered body is fitted in the expanded aluminum base material. After that, cooling them to a room temperature, and thereby the cylindrical pipe yttria sintered body and the aluminum base material can be integrated owing to the shrink fitting. Preferably, an yttria thermal spray coating is applied to a portion that is exposed to a corrosive gas.

Normally, a diameter of the gas discharge hole is 0.5 mm or more. Inside of the gas discharge hole, a corrosive gas is plasma-excited and attacks an inner wall of the gas discharge hole. Accordingly, in the case of alumina or aluminum being used, particles are generated therein. However, in the gas diffusion plate according to the invention, since yttria is 10 or more times larger in plasma resistance than alumina (which means that the etching rate of yttria is one tenth or less than that of alumina), when the gas diffusion hole is coated with yttria, the generation of particles and contamination to the wafer can be inhibited.

A manufacturing method for a gas diffusion plate according to a second embodiment of the invention is carried out as follows.

As shown in FIG. 5, a disk-like aluminum base material 3 provided with one or more circular through holes 2 and a columnar solid sintered yttria body 5 are prepared. Then, the base material 3 is heated, and the sintered body 5 is inserted in the circular through hole 2. After that, heating the base material 3 in which the sintered body 5 is inserted, and by making use of the difference of the thermal contractions of the yttria and aluminum, the sintered body 5 is shrink fitted to the circular through hole 2. Next, as shown in FIG. 3, the boring is applied to the sintered body 5 to form a gas discharge hole 4, and furthermore an yttria thermal spray coating 6 is applied to a portion of the base material 3 exposed to a corrosive gas.

Specifically, a columnar solid sintered yttria body sintered in advance at substantially 1800° C. is prepared, and one or more, preferably 100 or less, circular through holes are bored at a hole diameter larger by substantially 0 to 0.3 mm than a hole diameter of the sintered body in the aluminum base material.

The aluminum base material, in which the circular through holes are bored, is heated at a temperature equal to or more than 300° C., the columnar sintered body is fitted in the circular through hole of an expanded aluminum base material followed by cooling to a room temperature, and thereby the columnar sintered yttria body and the aluminum base material are shrink fitted and integrated. In addition, an yttria thermal spray coating is applied to a portion exposed to a corrosive gas.

When a usage temperature of the shower plate is higher, it is preferable that the yttria thermal spray coating is formed as a two-layer structure in which as an outermost surface, a gas plasma thermal spray coating is applied on a water plasma thermal spray coating.

This is because, owing to the difference of the thermal expansion coefficients of the base material and the sintered body, when only the gas plasma thermal spray coating is applied, of which density is higher than that of water plasma thermal spray coating (which means that a number of porous in the gas plasma thermal spray coating is less than a number of porous in the water plasma thermal-spray coating), the thermal spray coating is likely to peel off. However, when the plasma resistance is taken into consideration, it is preferable that the outermost surface is preferably the gas plasma thermal spray coating which has high density. Accordingly, when the water plasma thermal spray coating is applied to alleviate the stress and the dense gas plasma thermal spray coating is applied on the outermost surface, a thermal spray coating that can be hardly peeled off and is excellent in the plasma resistance can be obtained. However, when a usage temperature is low, the gas plasma thermal spray coating alone is sufficient for use.

The drilling process is carried out with laser light or a drill. A dimension and a shape of the gas discharge hole 4 may be whatever adoptable. However, when the processability, the ventilation resistance and adhesion of the particles are considered, the shape is preferable to be circular, elliptic, oval or crescent. Furthermore, one sintered body may be provided with a plurality of gas discharge holes.

After the drilling process, it is preferable to eliminate anxieties of generation of particles by applying an annealing process at a temperature equal to or less than 900° C. to solidly adhere the particles.

According to the manufacturing method according to the second embodiment, since the drilling process is applied after the shrink fitting, the positional accuracy in the drilling can be easily obtained and responses to various special hole shapes can be enabled. Furthermore, in comparison with one where the drilling is applied to a single yttria, thus manufactured gas diffusion plate can be inhibited from being damaged owing to the thermal stress at the time of usage and is less expensive. In particular, as the gas diffusion plate becomes larger, it becomes less expensive.

### EXAMPLES

[Test 1]

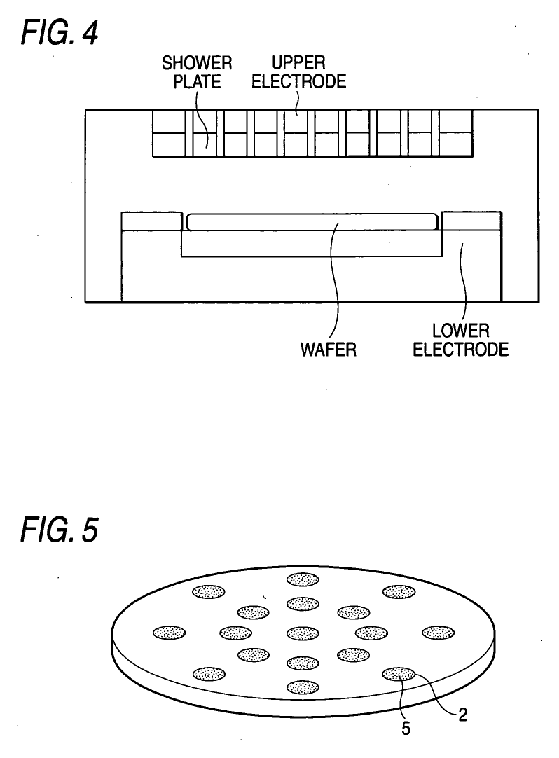

As shown in FIG. 4, a shower plate according to the invention was installed in a semiconductor etcher, a semiconductor wafer was set at a position lower than the shower plate, a plasma gas of CF₄+He+Ar was introduced from the shower plate, followed by discharging, and particles on the wafer were counted.

### Example 1

A shower plate in which a cylindrical yttria pipe was shrink-fitted in a circular through hole of a disk-like alumina base material such as shown in FIG. 1.

### Example 2

A shower plate in which an yttria thermal spray coating is applied to an exposed portion, which is exposed to a corrosive gas, of the alumina base material of the Example 1 as shown in FIG. 2.

### Comparative Example 1

A shower plate in which a gas discharge hole is bored in alumina.

### Comparative Example 2

A shower plate in which an yttria thermal spray coating is applied to a portion, which is exposed to the corrosive gas, of the alumina base material of the comparative example 1 (A thermal spray coating cannot apply to an inside of the gas discharge hole.).

### Comparative Example 3

A shower plate in which a cylindrical yttria pipe is adhered to a through hole of alumina with an adhesive.

Results: Table 1 shows results.

TABLE 1

| | | Gas | Particles/ | Component |
|---|---|---|---|---|
| | | Discharge | Wafer | of |
| Sample | Base Material | Hole | (pieces) | particle |
| Example 1 | Alumina | Shrink fitted | 0 | — |
| | | cylindrical | | |
| | | yttria pipe | | |
| Example 2 | Alumina + Yttria | Shrink fitted | 0 | — |
| | thermal spray | cylindrical | | |
| | coating | yttria pipe | | |
| Comparative | Alumina | Alumina | 200 | Al₂O₃ |
| example 1 | | | | |
| Comparative | Alumina + Yttria | Alumina | 150 | Al₂O₃, |
| example 2 | thermal spray | | | Y₂O₃ |
| | coating | | | |
| Comparative | Alumina | Shrink fitted | 50 | Al₂O₃, |
| example 3 | | cylindrical | | Organics |
| | | yttria pipe | | |

As obvious from Table 1 as well, there was no particle generation in Examples 1 and 2.

On the other hand, in the Comparative example 1 where alumina is exposed in the gas discharge hole, as many as 200 particles were generated and the component of the particle was alumina. In the Comparative example 2 where an yttria thermal spray coating was applied to the Comparative example 1, in comparison with the comparative example 1, the number of generated particles decreased to 150. However, there were found Y₂O₃ particles mingled with alumina particles. In the Comparative example 3 where the cylindrical yttria pipe was adhered to the through hole of alumina with an adhesive, the number of the particles, though less than that of the Comparative examples 1 and 2, was larger than that of the Examples 1 and 2. In addition, there were organic particles other than alumina particles in the particles.

[Test 2]

In place of the alumina base material in the Example 1, an aluminum base material was used, and thereby a shower plate according to Example 3 was prepared. In place of the alumina base material according to the Comparative example 2, an aluminum base material was used, and thereby a shower plate according to comparative example 4 where a gas discharge hole was made of aluminum was prepared. Furthermore, in place of the alumina base material in the Comparative example 3, an aluminum base material was used, and thereby a shower plate according to Comparative example 5 was prepared. Similarly to the test 1, particles on the wafer were counted.

Results are shown in Table 2.

TABLE 2

| | | Gas | Particles/ | Component |
|---|---|---|---|---|
| | | Discharge | Wafer | of |
| Sample | Base Material | Hole | (pieces) | particle |
| Example 3 | Aluminum + | Shrink fitted | 0 | — |
| | Yttria thermal | cylindrical | | |
| | spray coating | yttria pipe | | |
| Comparative | Aluminum + | Aluminum | 150 | — |
| example 4 | Yttria thermal | | | |
| | spray coating | | | |
| Comparative | Aluminum + | Adhesion of | 70 | Al₂O₃, |
| example 5 | Yttria thermal | cylindrical | | Y₂O₃, |
| | spray coating | yttria pipe | | organics |

As obvious from Table 2, example 3 where the aluminum base material was used as well, similarly to Examples 1 and 2 where the alumina base material was used, there was no particle generation.

On the other hand, in Comparative example 4 where aluminum was exposed at the gas discharge hole, as many as 150 particles were generated and the components thereof were Al₂O₃ and Y₂O₃. In Comparative example 5 where the cylindrical yttria pipe was bonded to the through hole of aluminum base material in Comparative example 4 with an adhesive, the number of the particles was 70, which is less than that of Comparative example 4 but larger than that of Example 3. In addition, in the particles, other than Al₂O₃ and Y₂O₃, the organics were found mingled.

[Test 3]

With the shower plate according to the invention, which is provided with an aluminum base material, in a manner similar to test 1, the particles were counted.

As Example 4, in place of the columnar yttria pipe according to example 3, the shower plate in which the drilling process was applied to a columnar solid sintered body to form a gas discharge hole is used. The plasma thermal spray coating in the Example 4 was formed into a two layer structure of a water plasma thermal spray coating and a gas plasma thermal spray coating at the outermost surface.

Results are shown in Table 3.

TABLE 3

| | | Gas | Particles/ | Component |
|---|---|---|---|---|
| | | Discharge | Wafer | of |
| Sample | Base Material | Hole | (pieces) | particle |
| Example 4 | Aluminum + | Shrink fitting of | 20 | Al₂O₃, Y₂O₃ |
| | Yttria thermal | sintered yttria | | |
| | spray coating | Drilling | | |

As obvious from Table 3 as well, in example 4 where the drilling process was applied to the columnar solid sintered body to form a gas discharge hole, only a few particles were generated.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A gas diffusion plate comprising:
an alumina or an aluminum base material provided with one or more through holes; and
an yttria body shrink-fitted to one of the through holes, the yttria body provided with one or more gas discharge holes.

2. The gas diffusion plate according to claim 1, wherein an yttria thermal spray coating is provided on an exposed portion of the alumina or aluminum base material, which is exposed to a corrosive gas.

3. The gas diffusion plate according to claim 1, wherein the through hole of the alumina or the aluminum base material is circular, and the yttria body is cylindrical.

4. A manufacturing method for a gas diffusion plate comprising the steps of:
preparing a prior to sintering alumina base material provided with one or more through holes and a sintered hollow yttria body provided with one or more gas discharge holes;
inserting the sintered hollow yttria body into one of the through holes of the prior to sintering alumina base material; and
sintering the alumina base material together with the sintered hollow yttria body so as to shrink-fit the hollow yttria body to one of the through holes of the alumina base material.

5. The manufacturing method for the gas diffusion plate according to claim 4, further comprising a step of:
performing an yttria thermal spray coating on an exposed portion of the alumina base material, which is exposed to a corrosive gas.

6. A manufacturing method for a gas diffusion plate comprising the steps of:
preparing a prior to sintering alumina base material provided with one or more through holes and a solid sintered yttria body;
inserting the solid sintered yttria body into one of the through holes of the alumina base material;
sintering the alumina base material together with the solid sintered yttria body so as to shrink-fit the solid sintered yttria body to one of the through holes; and
drilling the solid sintered yttria body so as to form one or more gas discharge holes therein.

7. The manufacturing method for the gas diffusion plate according to claim 6, further comprising a step of:
performing an yttria thermal spray coating on an exposed portion of the alumina base material, which is exposed to a corrosive gas.

8. A manufacturing method for a gas diffusion plate comprising the steps of:
preparing an aluminum base material provided with one or more through holes and a hollow sintered yttria body provided with one or more gas discharge holes;
inserting the hollow sintered yttria body into one of the through holes of the aluminum base material while heating the aluminum base;
cooling the hollow sintered yttria body and the aluminum base material so as to shrink-fit the hollow sintered yttria body to one of the through holes.

9. The manufacturing method for the gas diffusion plate according to claim 8, further comprising a step of:
performing an yttria thermal spray coating on an exposed portion of the aluminum base material, which is exposed to a corrosive gas.

10. A manufacturing method for a gas diffusion plate comprising the steps of:
preparing an aluminum base material provided with one or more through holes and a solid sintered yttria body;
inserting the solid sintered yttria body into one of the through holes of the aluminum base plate;
cooling the aluminum base material and the solid sintered yttria body so as to shrink-fit the solid sintered yttria body to one of the through holes; and
drilling the solid sintered yttria body to form one or more gas discharge holes.

11. The manufacturing method for the gas diffusion plate according to claim 9, further comprising a step of:
performing an yttria thermal spray coating on an exposed portion of the aluminum base material, which is exposed to a corrosive gas.
